(19) United States
(12) Patent Application Publication
(10) Pub. No.: US 2008/0000329 A1
(43) Pub. Date: Jan. 3, 2008

(54) Extraction Device

(76) Inventors: Laurence Ross Petrie, Western Australia (AU); Karl Michael Jackson, Western Australia (AU); Ian Colin George, Western Australia (AU)

Correspondence Address: KEVIN J. MCNEELY, ESQ., 5335 WISCONSON AVENUE, NW, SUITE 440, WASHINGTON, DC, 20015, US

(21) Appl. No.: 10/598,164

(22) PCT Filed: Feb. 18, 2005
(86) PCT No.: PCT/AU05/00223

§ 371 Date: Aug. 21, 2007

(30) Foreign Application Priority Data
Feb. 19, 2004 (AU) 2004900823

(51) Int. Cl. B25B 13/50

(52) U.S. Cl. 81/53.2

(57) ABSTRACT

An extraction device (10) for facilitating removal of a sheared fastening element (13) in threaded engagement with a member (17). The extraction device (10) comprises of a hollow body (30) defining a cavity (33) for receiving an exposed portion of the sheared fastening element (13). The body (30) has a first face (31) onto which the cavity (33) opens to define an opening (35) through which the exposed portion (29) of the sheared fastening element (13) can be received, The cavity (33) has a boundary wall (35) with an inwardly stepped configuration (45) in the direction towards the opening (35). The stepped configuration (45) presents at least one edge (49) which facilitates welding of the body (30) to the exposed portion (29) of the sheared fastening element (13) received within the cavity.

### FIELD OF THE INVENTION

This invention relates to an extraction device to facilitate removal of sheared fastening elements. The invention has been devised particularly, but not solely, to facilitate extraction of sheared studs.

### BACKGROUND ART

Separation of corroded fasteners is often assisted by the application of heat and/or release agents. Where it can be done without causing damage, the application of heat can be particularly effective, as differential expansion created between the threadingly engaged parts is effective in cracking any intervening corrosion and thus facilitating extraction. However, where the female threaded hole accommodating the threaded fastener is incorporated in a large mass of metal, it can often be difficult to supply heat to an extent sufficient to enable the corrosive bond to be broken while avoiding damage through the intensity of the heat.

The issue can be further complicated in cases where the threaded connection involves a fastening element (such as a machine screw, bolt or stud) that has sheared. In such a situation, it can sometimes be extremely difficult to remove the remnant part of the shared fastening element from the body in which it is embedded without extensive damage to the body, even with the application of heat and/or chemical release agents.

There have been various proposals for facilitating removal of sheared fastening elements.

One proposal involves use of what is known as a “screw extractor”, which requires that a hole be drilled into the sheared fastener and an extraction tool engaged in the hole.

Another proposal involves welding a nut onto the sheared fastener, thereby enabling a tool such as a spanner to engage the nut so that an unthreading torque can be applied to the sheared fastener. An extraction device disclosed in Australian Patent 599513 is a development of such a proposal.

It is against this background, and the problems and difficulties associated therewith, that the present invention has been developed.

### DISCLOSURE OF THE INVENTION

According to a first aspect of the invention there is provided an extraction device for facilitating removal of a sheared fastening element, comprising a hollow body defining a cavity for receiving an exposed portion of the sheared fastening element, the body having a first face onto which the cavity opens to define an opening through which the exposed portion of the sheared fastening element can be received, the cavity having a boundary wall with an inwardly stepped configuration in the direction towards the opening.

Preferably, the cavity is of generally circular cross-section, with the stepped configuration providing at least step which is generally annular.

The stepped configuration provides a plurality of such steps.

With this arrangement, the stepped configuration presents at least one edge which facilitates welding of the body to the exposed portion of the sheared fastening element received within the cavity.

Preferably, the stepped configuration presents a series of edges.

Further, the stepped configuration may assist in directing heat imparted during the welding process directly onto the sheared fastener rather than onto the body of the device or the parent body into which the sheared fastener is itself fastened. In this way, heat will transfer along the sheared fastener and the latter will be much hotter, and therefore thermally expand more than the surrounding parent body. In this respect, the corrosion between the sheared fastener and the parent body can be of assistance, as the common metal oxides (such as ferrous oxide) are a poor conductor of heat and, consequently, act as an insulator between the sheared fastener and the parent body. This allows more heat to be directed along the sheared fastener.

Still further, as a consequence of the stepped configuration, slightly more weld material is required to fill the cavity, thereby increasing the amount of heat supplied.

Preferably, the hollow body has an outer periphery configured for engagement by a tool (such as a spanner) for applying torque thereto.

Preferably, said first face on the body has an outer periphery disposed inwardly of the outer periphery of the body. This arrangement has the advantage of reducing the surface area of the body in contact with the parent material, thereby reducing heat transfer directly from the hollow body to the parent body and thus enhancing heat transfer from the hollow body to the sheared fastener element.

According to a second aspect of the invention there is provided an extraction device for facilitating removal of a sheared fastening element, comprising a hollow body defining a cavity for receiving an exposed portion of the sheared fastening element, the body having a first face onto which the cavity opens to define an opening through which the exposed portion of the sheared fastening element can be received, the cavity having a boundary wall presenting a plurality of edges at spaced intervals on the boundary wall as per claim 6.

Accordingly to a third aspect to the invention there is provided an extraction device for facilitating removal of a sheared fastening element, comprising a hollow body defining a cavity for receiving an exposed portion of the sheared fastening element, the body having a first face onto which the cavity opens to define an opening through which the exposed portion of the sheared fastening element can be received, the hollow body having an outer periphery configured for engagement by a tool for applying torque thereto, and a rebate provided in the body around the first face whereby the first face has an outer periphery disposed inwardly of the outer periphery of the body per claim 10.

Thus the present invention provides a device which facilitates extraction of a sheared fastening element and which utilises heat generated in the act of welding the device to the sheared fastening element to assist in the removal process.

### BRIEF DESCRIPTION OF THE DRAWINGS

The invention will be better understood by reference to the following description of one specific embodiment thereof as shown in the accompanying drawings in which:

FIG. 1 is a schematic sectional elevational view of an extraction device according to the embodiment;

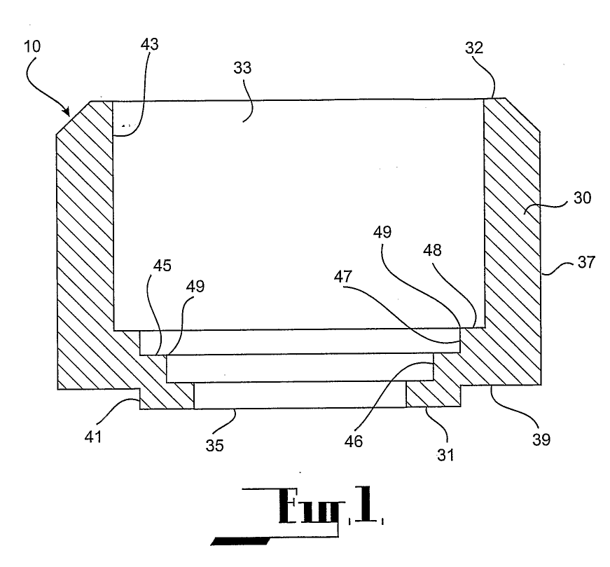

FIG. 2 is a schematic sectional side view of a typical bolted connection utilising a threaded fastener embedded in a parent body, this being an arrangement where an extraction device according to the embodiment might be used in the event of shearing of the threaded fastener;

FIG. 3 is a view similar to FIG. 2, except that the bolted connection is shown in a condition in which the threaded fastener has sheared;

FIG. 4 is a schematic view illustrating the sheared threaded fastener in position in the parent body, with the sheared threaded fastener having been filed or ground at the fractured end thereof to facilitate positioning of the extraction device according to the embodiment thereon;

FIG. 5 is a schematic sectional view illustrating the extraction device positioned on the sheared threaded fastener in readiness to be welded thereto;

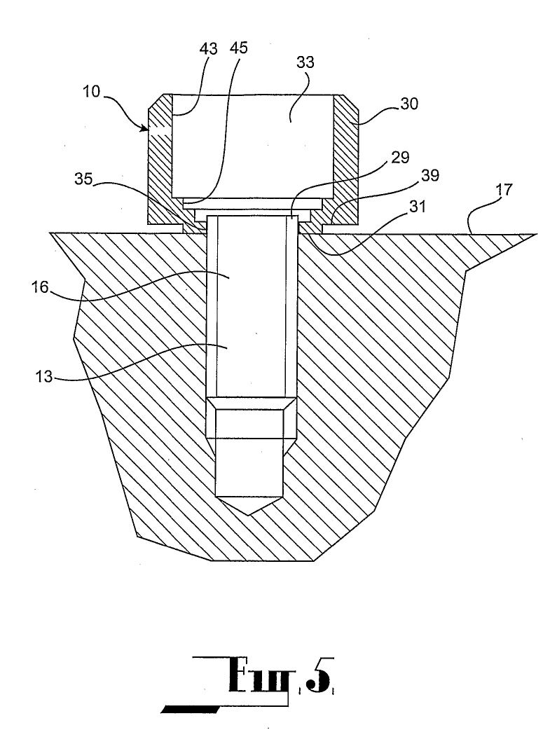

FIG. 6 is a schematic sectional view illustrating the extraction device being welded to the sheared threaded fastener; and

FIG. 7 is a schematic sectional view illustrating the extraction device welded to the sheared threaded fastener, in readiness for removal of the sheared fastener by engaging the extraction device with a tool for applying a rotation torque thereto to unthread the fastener.

### BEST MODE(S) FOR CARRYING OUT THE INVENTION

The embodiment is directed to an extraction device 10.

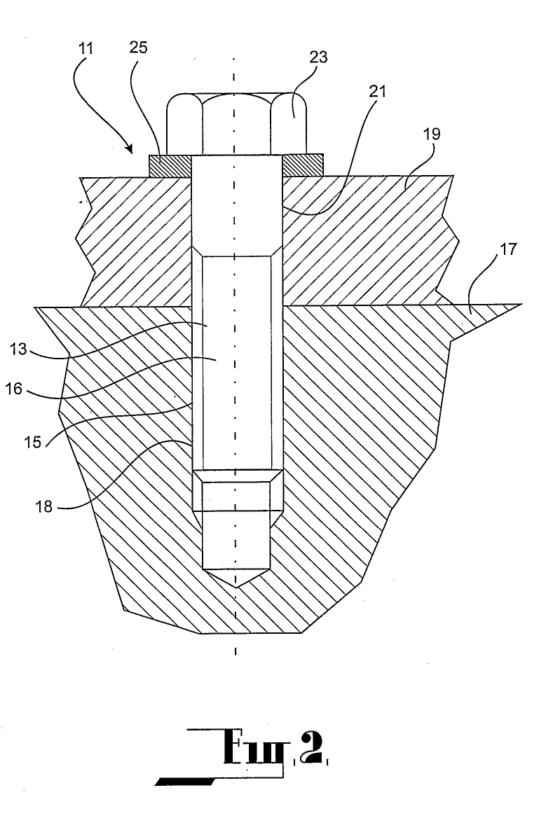

The embodiment will be described with reference to a bolted connection 11 between a first member 17 and a second member 19, as shown in FIG. 2. The bolted connection 11 comprises a fastening element in the form of a stud 13 threadingly engaged in a hole 15 formed in parent metal defining the first member 17. The stud 13 comprises a shank 16 having a first threaded section 18 in engagement with the hole 15 and a head 23 on one end of the shank. The second member 19 is fastened to the first member 17 by way of the bolted connection 11. The second member 19 has a mounting hole 21 formed therein through which the stud 13 is slidably received. The second member 19 is secured in position with respect to the first member 17 by way of the head 23, together with a washer 25.

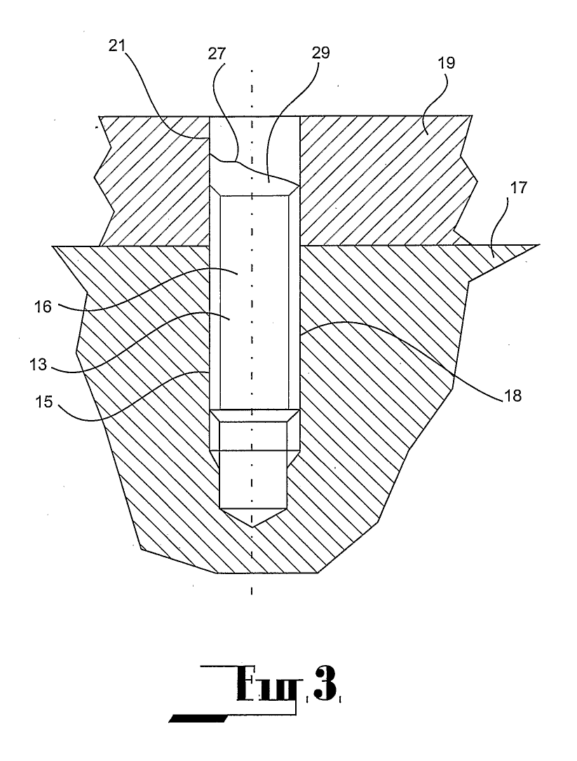

Failure of the bolted connection 20 would typically occur by breakage of the stud 13 at the root of the threaded section 18 provided for engagement with the parent metal, producing a classical fracture 27 as illustrated in FIG. 3 of the drawings. Thus, the fractured stud 13 has an exposed portion thereof 29 projecting beyond the parent metal defining the first member 17, as can be seen in FIG. 3 (once the second member 19 has been removed, as the bolted connection 20 is no longer effective).

The extraction device 10 according to the embodiment comprises a hollow body 30 having a first face 31 and a second face 32 in opposed relation to the first face. The hollow body 30 incorporates an internal cavity 33 opening onto the first face 31 by way of circular opening 35. The hollow body 30 also has an outer periphery 37 which is hexagonally configured to be gripped by a suitably sized spanner.

An annular rebate 39 is formed in the hollow body 30 around the first face 31. The rebate 39 forms a cylindrical wall 41 which constitutes the outer limit of the first face 31.

The cavity 33 has a boundary wall 43 incorporating a stepped configuration 45 in the region adjacent the opening 35. The stepped configuration 45 involves at least one step, although in this embodiment there are a plurality of such steps 46. Each step 46 comprises an axial face 47 and a transverse face 48, with the junction therebetween defining an edge 49. With this arrangement, the boundary wall 43 presents a plurality of edges 49 at spaced intervals thereon, the edges being generally annular and concentric with the opening 35.

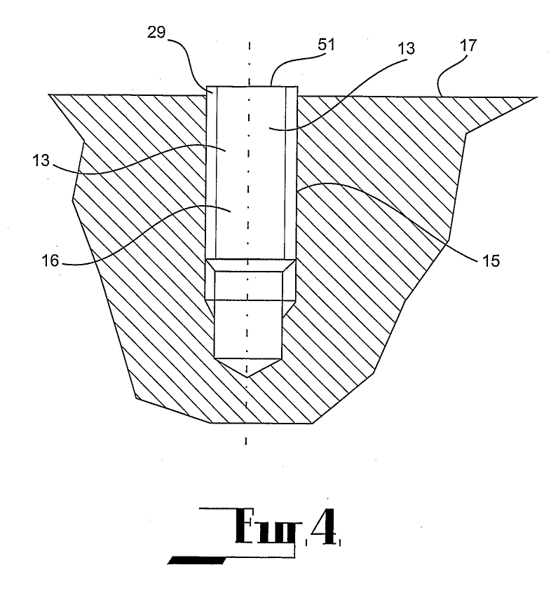

The opening 35 is dimensioned to receive the exposed portion 29 of the fractured stud 13, after the fracture has preferably first been filed or ground to present a flat face 51, as shown in FIG. 4.

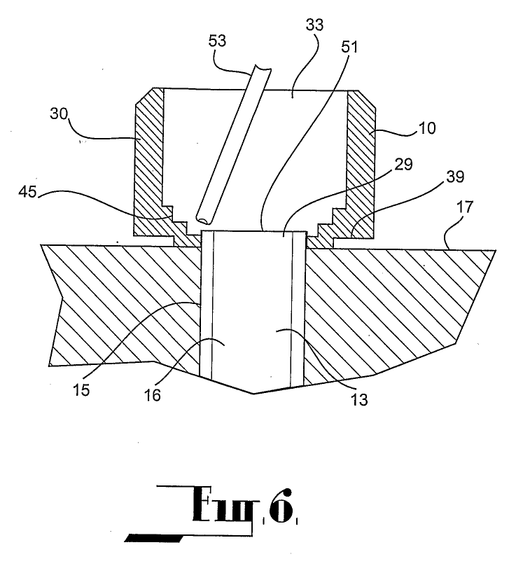

The extraction device 10 is fitted onto the exposed portion 29 of the fractured stud 13 after the face 51 has been formed, with the exposed portion 29 of the fractured stud 13 extending through the opening 35 into the cavity 33. The extraction device 10 can then be welded to the exposed portion 29 of the fracture stud 13 within the cavity 33. This is illustrated in FIG. 6 of the drawings, where a arc welding rod 53 can be seen inserted into the cavity 33 and about to be positioned to strike an arc for welding the device 10 to the fractured stud 13.

The edges 49 defined by the stepped configuration 45 are advantageous in that their presence facilitates striking an arc to effect the welding operation.

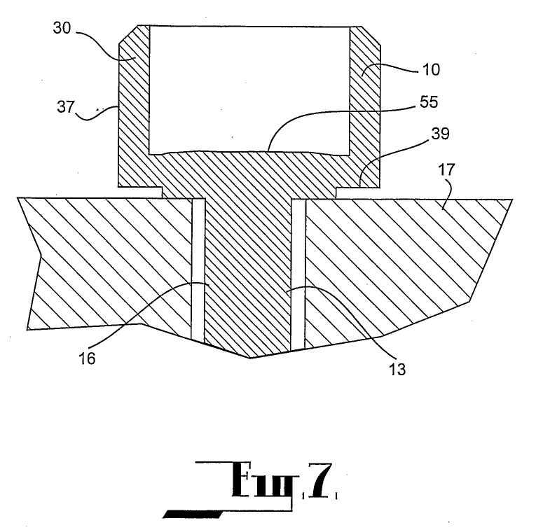

During the welding process, weld metal 55 is applied, partially filling the cavity 33, as can be seen in FIG. 7 of the drawings.

Heat generated by the welding process, including in particular deposition of weld material 55 in the cavity 33, results in heat transfer to the threaded stud 13. Because of the presence of the rebate 39, there is a reduced contact area between the first face 31 of the extraction device 10 and the adjacent face of the parent metal defined by first member 17. This reduced contact area lessens heat transfer directly between the extraction device 10 and the parent metal, thereby focusing heat transfer directly to the shank 16 of the fractured stud 13. Consequently, there is greater heat transfer to the fractured stud 13 than the parent metal defined by first member 17, thereby causing the fractured stud to expand thermally more than the parent metal. The different expansion rates lead to fracturing of the corrosive bond between the fractured stud 13 and the parent metal. This breaks the corrosive bond between the fractured stud 13 and the parent metal, making the extraction process easier. Corrosion in the threaded connection between the fractured stud 13 and the parent metal is of assistance in that it is a poor conductor of heat and, as such, ensures that there is greater heat transfer along the shank 16 of the fractured stud 13 and less heat dissipation from the fractured stud 13 into the parent metal.

Once the extraction device 10 has been welded to the fractured stud 13, it can be engaged by a spanner and rotated to effect unthreading of the stud 13 from the parent metal defined by the first member 17.

The extraction device 10 can be made in various sizes to accommodate threaded studs of various diameters. However, it may be possible to use a common extraction device for studs of a range of diameters, by drilling the opening 35 to the appropriate size as necessary. This should be possible in cases where the stepped configuration 45 includes a plurality of steps, 46, as is the case in the present embodiment. With this arrangement, the opening 35 can be bored to an increased size, so long as part of the first face 31 remains intact and also there remains at least one edge 49 within the cavity 33 upon which an arc can be struck for the welding process.

From the foregoing, it is evident that the present embodiment provides a simple yet highly effective device for extracting fractured fasteners. The device according to the embodiment provides a mechanical connection to the fractured stud in order to facilitate its removal. The configuration of the device is such that heat generated in the welding process for attachment of the device to the fractured stud is utilised in assisting the removal process. This is particularly advantageous and contributes to the effective operation of the extraction device.

Modifications and improvements may be made without departing from the scope of the invention.

Throughout the specification, unless the context requires otherwise, the word “comprise” or variations such as “comprises” or “comprising”, will be understood to imply the inclusion of a stated integer or group of integers but not the exclusion of any other integer or group of integers.

1. An extraction device for facilitating removal of a sheared fastening element, comprising a hollow body defining a cavity for receiving an exposed portion of the sheared fastening element, the body having a first face onto which the cavity opens to define an opening through which the exposed portion of the sheared fastening element can be received, the cavity having a boundary wall with an inwardly stepped configuration in the direction towards the opening.

2. An extraction device according to claim 1 wherein, the cavity is of generally circular cross-section, with the stepped configuration providing at least one step which is generally annular.

3. An extraction device according to claim 2 wherein the stepped configuration provides a plurality of such steps

4. An extraction device according to claim 1,2 and 3 wherein, the hollow body has an outer periphery configured for engagement by a tool for applying torque thereto.

5. An extraction device according to claim 4 wherein, said first face on the body has an outer periphery disposed inwardly of the outer periphery of the body.

6. An extraction device for facilitating removal of a sheared fastening element, comprising a hollow body defining a cavity for receiving an exposed portion of the sheared fastening element, the body having a first face onto which the cavity opens to define an opening through which the exposed portion of the sheared fastening element can be received, the cavity having a boundary wall presenting a plurality of edges at spaced intervals on the boundary wall.

7. An extraction device according to claim 6 wherein the steps are generally annular and concentric with said opening.

8. An extraction device according to claim 6 or 7 wherein the boundary wall is of stepped configuration to define said edges.

9. An extraction device accordingly to claim 8 or 9 wherein a rebate is provided in the body around the first face.

10. An extraction device for facilitating removal of a sheared fastening element, comprising a hollow body defining a cavity for receiving an exposed portion of the sheared fastening element, the body having a first face onto which the cavity opens to define an opening through which the exposed portion of the sheared fastening element can be received, the hollow body having an outer periphery configured for engagement by a tool for applying torque thereto, and a rebate provided in the body around the first face whereby the first face has an outer periphery disposed inwardly of the outer periphery of the body.

11. An extraction device substantially as herein described with reference to the accompanying drawings.
